(19) United States
(12) Patent Application Publication
(10) Pub. No.: US 2025/0227642 A1
(43) Pub. Date: Jul. 10, 2025

(54) TIMING ADVANCE FOR NTN POSITIONING

(71) Applicant: QUALCOMM Incorporated, San Diego, CA (US)

(72) Inventors: Chiranjib SAHA, Lakeside, CA (US); Alberto RICO ALVARINO, San Diego, CA (US); Harikumar KRISHNAMURTHY, San Diego, CA (US); Alexandros MANOLAKOS, Athens (GR)

(21) Appl. No.: 18/847,119

(22) PCT Filed: Mar. 29, 2023
(86) PCT No.: PCT/US2023/016673

§ 371 Date: Sep. 13, 2024

(30) Foreign Application Priority Data
Jun. 1, 2022 (GR) 20220100463

(51) Int. Cl. H04W 56/00; H04W 64/00; H04W 84/06

(52) U.S. Cl. CPC H04W 56/0045; H04W 56/006; H04W 64/006; H04W 84/06

(57) ABSTRACT

In some implementations, a user equipment (UE) may determine a UE-specific timing advance adjustment value, wherein: the UE-specific timing advance adjustment value is indicative of a propagation delay between a non-terrestrial vehicle of the NTN and the UE, and the propagation delay is determined based on a distance between an estimated location of the UE and an estimated location of the non-terrestrial vehicle. The UE may send the UE-specific timing advance adjustment value in a message to a network node of the data communication network.

### RELATED APPLICATIONS

This application claims the benefit of Greek application No. 20220100463, filed Jun. 1, 2022, entitled “TIMING ADVANCE FOR NTN POSITIONING”, which is assigned to the assignee hereof, and incorporated herein in its entirety by reference.

### BACKGROUND

### 1. Field of Disclosure

The present disclosure relates generally to the field of radiofrequency (RF)-based position determination (or positioning) of an electronic wireless device. More specifically, the present disclosure relates to Non-Terrestrial Network (NTN)-based positioning.

### 2. Description of Related Art

The positioning of devices can have a wide range of consumer, industrial, commercial, military, and other applications. NTN-based positioning offers coverage for positioning applications in addition or as an alternative to Terrestrial Network (TN)-based positioning. NTN-based positioning can be used for network verification of the location of a user equipment (UE), as well as positioning of the UE. To enable such functionality, a timing advance adjustment may be provided for the UE.

### BRIEF SUMMARY

An example method at a user equipment (UE) of reporting time advance of the UE for non-terrestrial network (NTN) positioning in a data communication network, according to this disclosure, may comprise determining, at the UE, a UE-specific timing advance adjustment value, wherein the UE-specific timing advance adjustment value is indicative of a propagation delay between a non-terrestrial vehicle of the NTN and the UE, and the propagation delay is determined based on a distance between an estimated location of the UE and an estimated location of the non-terrestrial vehicle. The method also may comprise sending the UE-specific timing advance adjustment value in a message to a network node of the data communication network.

An example method at a next generation radio access network (NG-RAN) node of reporting time advance of a user equipment (UE) for non-terrestrial network (NTN) positioning in a data communication network, according to this disclosure, may comprise receiving from the UE, at the NG-RAN node, a UE-specific timing advance adjustment value, wherein the UE-specific timing advance adjustment value is indicative of a propagation delay between a non-terrestrial vehicle of the NTN and the UE, and the propagation delay is reflective of a distance between an estimated location of the UE and an estimated location of the non-terrestrial vehicle. The method also may comprise sending the UE-specific timing advance adjustment value in an Enhanced Cell ID (ECID) message to a location server of the data communication network.

An example user equipment (UE) for reporting time advance of the UE for non-terrestrial network (NTN) positioning in a data communication network, according to this disclosure, may comprise a transceiver, a memory, one or more processors communicatively coupled with the transceiver and the memory, wherein the one or more processors are configured to determine a UE-specific timing advance adjustment value, wherein: the UE-specific timing advance adjustment value is indicative of a propagation delay between a non-terrestrial vehicle of the NTN and the UE, and the propagation delay is determined based on a distance between an estimated location of the UE and an estimated location of the non-terrestrial vehicle. The one or more processors further may be configured to send, via the transceiver, the UE-specific timing advance adjustment value in a message to a network node of the data communication network.

An example NG-RAN for reporting time advance of a user equipment (UE) for non-terrestrial network (NTN) positioning in a data communication network, according to this disclosure, may comprise a transceiver, a memory, one or more processors communicatively coupled with the transceiver and the memory, wherein the one or more processors are configured to receive from the UE, via the transceiver, a UE-specific timing advance adjustment value, wherein: the UE-specific timing advance adjustment value is indicative of a propagation delay between a non-terrestrial vehicle of the NTN and the UE, and the propagation delay is reflective of a distance between an estimated location of the UE and an estimated location of the non-terrestrial vehicle. The one or more processors further may be configured to send, via the transceiver, the UE-specific timing advance adjustment value in an Enhanced Cell ID (ECID) message to a location server of the data communication network.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication network.

FIG. 3 is a graph illustrating aspects of a non-terrestrial network (NTN) system, according to an embodiment.

FIGS. 4A and 4B are diagrams illustrating how timing advance can work in a communication network, including one that utilizes NTN communication and/or positioning.

FIG. 5 is a call flow diagram of an Enhanced Cell ID (ECID) positioning method, according to an embodiment.

FIG. 6 is a flow diagram of a method at a user equipment (UE) of reporting time advance of the UE for NTN positioning in a data communication network, according to an embodiment.

FIG. 7 is a flow diagram of a method at a next generation radio access network (NG-RAN) node of reporting time advance of a UE for NTN positioning in a data communication network, according to an embodiment.

FIG. 8 is a block diagram of an embodiment of a UE, which can be utilized in embodiments as described herein.

FIG. 9 is a block diagram of an embodiment of a base station, which can be utilized in embodiments as described herein.

FIG. 10 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

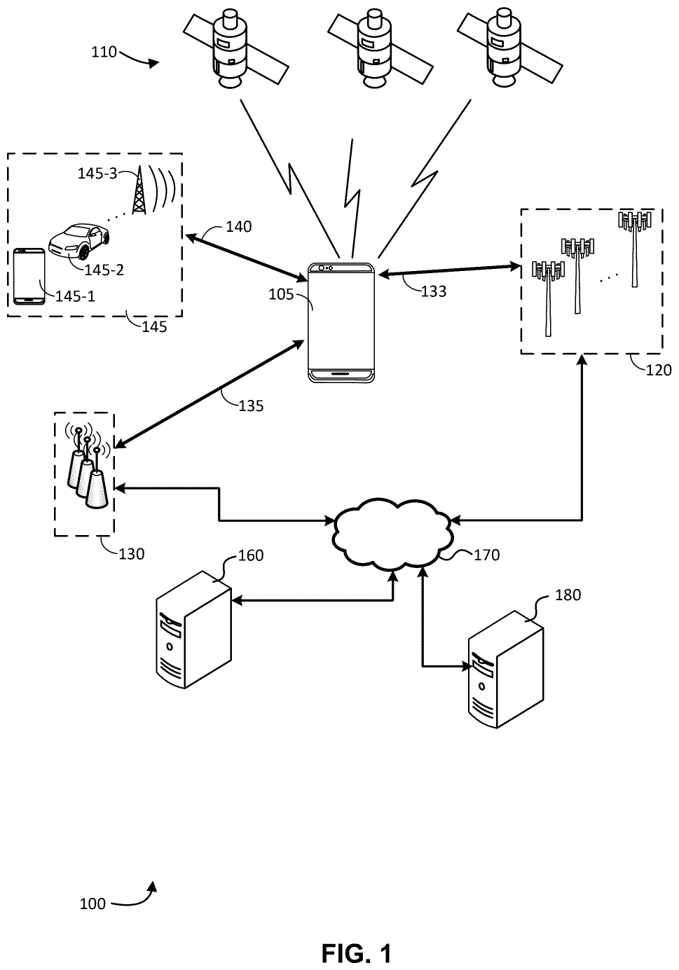

Non-Terrestrial Network (NTN)-based positioning (also referred to herein as “NTN positioning”) makes use of RF signals transmitted by non-terrestrial network nodes, such as satellites and aerial vehicles, to enable the positioning of a mobile device. In a cellular/mobile broadband network, such a mobile device comprises a UE. NTN-based positioning may be used in addition or as an alternative to Terrestrial Network (TN)-based positioning in which network nodes may transmit and/or receive RF signals to/from a UE for positioning of the UE. In some embodiments NTN positioning may be used as one of many techniques for positioning an electronic device in a positioning system. FIG. 1 provides an example of such a positioning system.

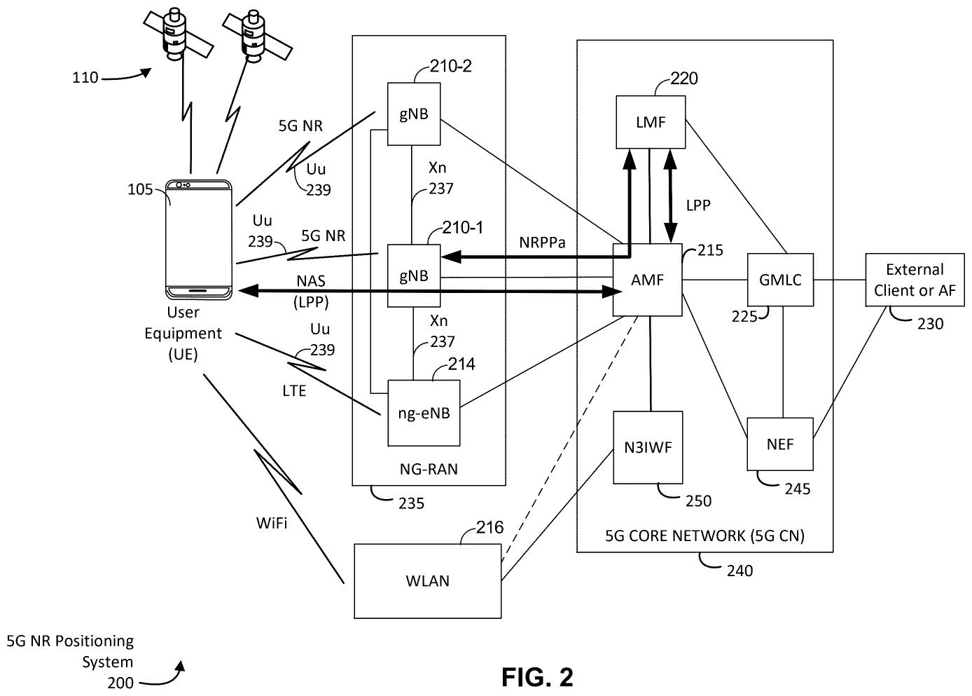

FIG. 1 is a simplified illustration of a positioning system 100 in which a UE 105, location server 160, and/or other components of the positioning system 100 can use the techniques provided herein for implementing an NTN timing advance when determining an estimated location of UE 105, according to an embodiment, according to an embodiment. The techniques described herein may be implemented by one or more components of the positioning system 100. The positioning system 100 can include: a UE 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards.

According to some embodiments, such as when the UE 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. Additional components of the 5G NR positioning system 200 are described below. The 5G NR positioning system 200 may include additional or alternative components.

The 5G NR positioning system 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites that may be communicatively coupled with the LMF 220 and may operatively function as a TRP (or TP) in the NG-RAN 235. As such, satellites 110 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhanced Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), RSTD, Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

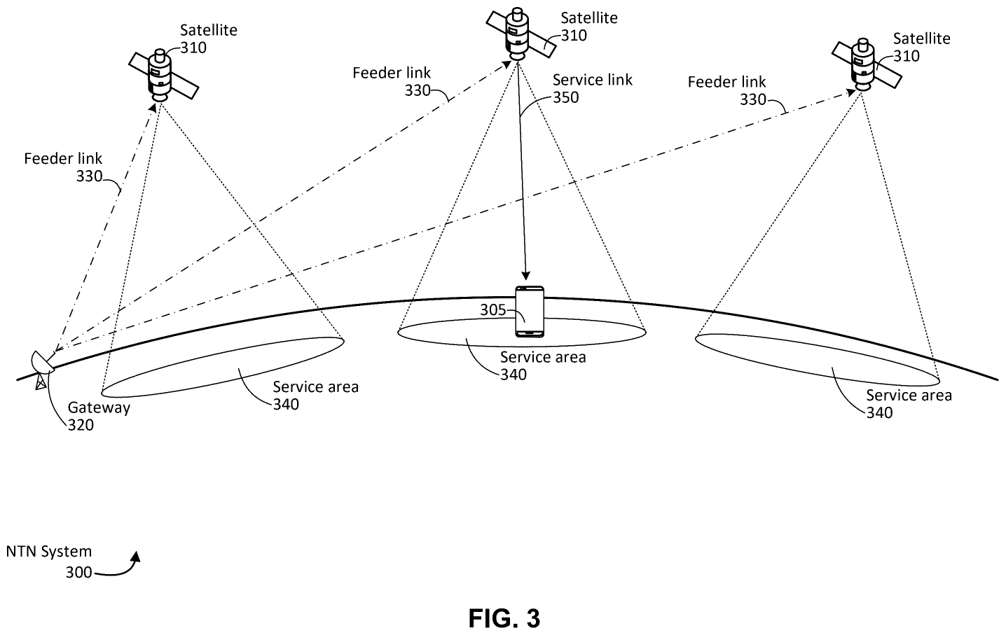

FIG. 3 is a graph illustrating aspects of an NTN system 300, which may be utilized to communicate data and/or provide positioning of a UE 305 (which may correspond to UE 105 of FIGS. 1 and 2), and may be part of a larger communication and/or positioning system (e.g., 5G NR positioning system 200 of FIG. 2). It can be noted that, although the NTN system 300 illustrated in FIG. 3 illustrates satellites 310 for enabling communications and/or positioning of the UE 305, embodiments are not so limited. An NTN system 300 may additionally or alternatively include other non-terrestrial vehicles (not shown in FIG. 3), including non-space vehicles such as high-altitude platform stations, balloons, airplanes, drones, etc.

The use of satellites 310 and/or other non-terrestrial vehicles to relay communication signals and/or provide positioning for a UE 305 can help provide availability and continuity in geographical regions that may not otherwise be easily serviceable using terrestrial-only means. Satellites 310 may include low earth orbit (LEO) satellites, medium earth orbit (MEO) satellites, and/or geostationary earth orbit (GEO) satellites. The satellites 310 (and/or other non-terrestrial vehicles in an NTN system 300) may connect with a 5G or other communication network via a gateway 320 or ground station using wireless RF feeder links 330. Satellites 310 may service corresponding service areas 340 (which may be divided into one or more subregions, or “beams”), and may establish a service link 350 with a UE within a corresponding service area 340. The service area 340 may move, corresponding with the movement of the respective satellite 310 a long its orbit. The service link 350 may serve as a Uu interface to the wireless network access to via the gateway 320. In some embodiments, the gateway 320 and/or satellites 310 may be associated with a base station of cellular network (e.g., gNB of a 5G network), and may comprise remote RUs and/or DUs of the base station, operatively functioning as TRPs, TPs, and/or RPs of the base station.

Positioning a UE 305 using an NTN system 300 may be similar to positioning in a cellular network (e.g., as previously described with regard to 5G NR positioning system 200 of FIG. 2). This can include, for example, the use of satellites 310 and/or other non-terrestrial vehicles of the NTN system 300 as transmission and/or reception points for transmitting and/or receiving reference signals for positioning the UE 305. Reference signals may then be used to perform positioning-related measurements, such as AoA, RTT, TDOA, etc., as previously described. A location server communicatively linked with the gateway 320 may be used to coordinate positioning sessions using the UE 305 and one or more of the satellites 310.

Among other things, NTN positioning may provide network-verified UE location, according to some embodiments. Network verification occurs when the network would like to verify the position of the UE as provided by the UE or another source. For example, the UE may provide the network with a GNSS-based position, but network may want to verify the location (e.g., within a specified or predetermined range) to ensure the location is not erroneous. This can be the case, for example, if GNSS spoofing of satellite signals is occurring in the location of the UE, or if the UE itself is spoofing its location intentionally. It can be noted, however, that embodiments are not limited to network verification of UE location. Embodiments may be used in other use cases and/or applications, such as NTN positioning, for example.

Given the relatively large distances between satellites 310 and/or other non-terrestrial components of an NTN system 300 (e.g., as compared with terrestrial networks), the corresponding timing advance also may be relatively large.

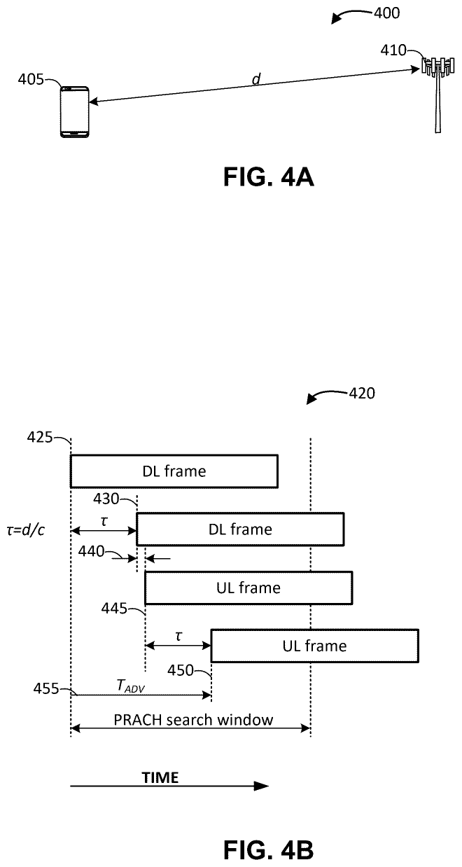

FIGS. 4A and 4B are diagrams illustrating how timing advance can work in a communication network (e.g., a 5G NR network), including one that utilizes NTN communication and/or positioning. FIG. 4A illustrates a simple scenario 400 used for illustrative purposes when describing timing advance. In particular, a UE 405 is separated from a TRP 410 (e.g., serving base station) by a distance, d. For single cell positioning/location verification, timing advance (T_{ADV}) of a received Physical Random Access Channel (PRACH) can be used as an estimator of RTT between the UE 405 and TRP 410. FIG. 4B provides additional information.

In a communication system utilizing Orthogonal Frequency Division Multiplexing (OFDM), such as LTE, NR, and others, time resources may be divided into frames, where DL frames are sent from the TRP 410 to the UE 405, and UL frames are sent from the UE 405 to the TRP 410. Timing advance can be used by the network to help enable the TRP 410 to synchronize UL frame boundaries of UL frames (from the UE 405 and any other UEs serviced by the TRP 410) with DL frame boundaries of DL frames transmitted by the TRP 410. Timing advance is a length of time, calculated for a specific UE 405, used by the UE 405 to transmit the UL frame in advance of the transmission of a corresponding DL frame, to help ensure the UL frame reaches the TRP 410 at approximately the same time the DL frame is transmitted. The length of the time advance for each UE will be proportional to the distance between the respective UE and the TRP.

FIG. 4B is a timing diagram 420 that helps illustrate how a timing advance works. Here, a downlink frame is transmitted by a TRP 410 beginning at a first point time 425. Due to distance d between the TRP 410 and UE 405, the DL frame does not reach the UE 405 and until a second point in time 430, which at a period of time τ after the first point in time 425, where τ=d/c (where c is the speed of light). For its part, the UE 405 will transmit a UL frame at time 445. If the UE 405 is in sync with the TRP 410, the lag 440 between the receipt of the DL frame at the second time 430 and the transmission of the UL frame at third time 445 is substantially small and negligible for most situations. Again, due to the distance d between the TRP 410 and UE 405, the UL frame experiences a lag time of τ. The time difference between the first point time 425 at which the DL frame is transmitted in the point in time 450 at which the UL frame (corresponding to the DL frame) would be received by the TRP 410 can be used as the time advance 455, which is roughly 2τ (an estimate of RTT). That is, if the UE 405 offsets the time of the UL frames by transmitting them in advance to receiving the DL frame (e.g., at second point in time 430) by the length of the timing advance 455, the corresponding UL frame for the received DL frame will reach the TRP 410 at substantially the time at which the corresponding DL frame is transmitted by the TRP (e.g., first point in time 425). And by determining a timing advance for all UEs it is serving, a TRP 410 can help ensure synchronicity of UL frame boundaries. The TRP 410 (or corresponding base station) may report the timing advance the UE 405 (and any other UEs it is serving) using ECID messages to a location server (e.g., an LMF). This can provide the LMF with an approximate location for the UE 405.

In terrestrial networks, a UE may not implement a timing advance prior to receiving a timing advance estimate from the network (e.g., during PRACH transmission). For NTN, however, a UE may implement a default/non-zero timing advance during the random access process. In particular, the UE may implement a common timing advance (referred to as N_{TA,adj}^{common} in relevant 3GPP specifications) related to feeder link delay in the NTN system, which may be signaled to the UE by the network along with an indication of a common timing advance drift, enabling the UE to determine the common timing advance at a particular time. Additionally, the UE may implement a UE-specific adjustment (N_{TA,adj}^{UE}) based on propagation delay between a satellite and the UE. This propagation delay may be based on the approximate location of the UE (e.g., obtained via GNSS) and the approximate location of the satellite (e.g., based on the ephemeris for the satellite). This additional parameters that compensate for satellite-related delays can help ensure residual delays fall within the ranges seen by terrestrial networks, allowing NTN networks to then utilize traditional terrestrial network timing advance estimation procedures.

Traditionally, these UE-side timing advance adjustments applied by the UE (N_{TA,adj}^{common} and N_{TA,adj}^{UE}) are not known by the network. That is, for a non-zero timing adjustment, T_{Adj}, where

$${T}_{Adj} = {N}_{TA , adj}^{common} + {N}_{TA , adj}^{UE} ,$$

$$then$$

$${T}_{ADV} \approx 2 τ - {T}_{Adj} .$$

This means that the residual timing adjustment determined by the network (which would exclude the term T_{Adj}) may be an inaccurate depiction of a timing adjustment, T_{ADV}, that reflects the UE's true position. Thus, to use T_{ADV} for positioning/location verification purpose at LMF, T_{Adj} may need to be signaled to the network.

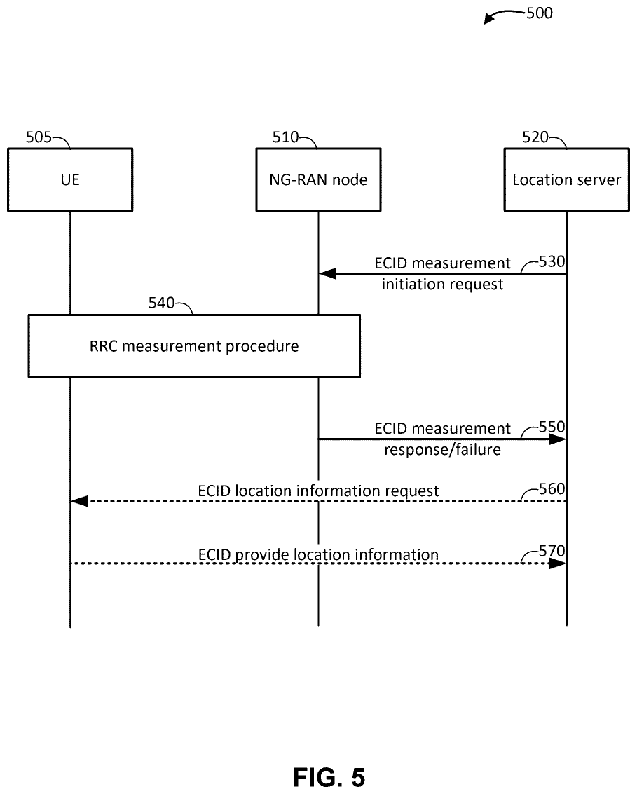

Embodiments herein provide for enabling a UE to report these UE-side timing advance adjustments, allowing the network to determine an accurate timing advance. To do so, embodiments may leverage messaging in an ECID positioning process, as described hereafter with regard to FIG. 5, for example. It can be noted, however, that although embodiments hereafter are described largely with regard to PRACH (random access), embodiments may utilize any UL reference signal, such as SRS.

FIG. 5 is a call flow diagram of an ECID positioning method 500 in which the position of a UE 505 (e.g., corresponding to one or more of the UEs of the above-described embodiments) is estimated with the knowledge of the geographical coordinates of its serving base station (e.g., ng-eNB or gNB). ECID for positioning includes techniques which a UE 505 and/or NG-RAN node 510 (e.g., a base station, NTN satellite, etc.) makes positioning-related measurements to improve a location estimate of the UE 505.

As illustrated, the process can include a location server 520 (e.g., an LMF in a 5G network) sending an ECID measurement initiation request to the NG-RAN node 510, as indicated at arrow 530. This request (and other communications between the NG-RAN node 510 and location server 520) may be made, for example, using NRPPa protocol. In response, the NG-RAN node 510 can engage in an RRC measurement procedure with the UE 505, as indicated at block 540. In the case of a serving base station, UL ECID may use inter-RAT NR, GSM EDGE Radio Access Network (GERAN), Universal Mobile Telecommunications System (UMTS) Terrestrial Radio Access (UTRA), or WLAN measurements reported by the UE 505, for example.

The NG-RAN node 510 can then report the ECID measurement response/failure to the location server 520, as indicated at arrow 550. For ECID positioning methods, the UE 505 may report (e.g., via the NG-RAN node 510) only the measurements that it has available rather than being required to take additional measurement actions. According to embodiments herein, timing advance values may be reported by the NG-RAN node 510 in the ECID measurement response/failure message of arrow 550.

In some embodiments, LPP communications between the UE 505 and location server 520 may allow for additional UE-specific measurements to be signaled by the UE to the LMF, as shown by optional arrows 560 and 570. This can include, for example, embodiments in which the location server 520 may request ECID location information (e.g., NR-ECID-RequestLocationInformation), as shown by arrow 560. In this case the UE 505 may provide a response (e.g., NR-ECID-ProvideLocationInformation), as shown by arrow 570, including measurements such as RSRP and RSRQ of SSB and CSI-RS. It can be noted that, in ECID positioning, the LPP messaging shown by arrows 560 and 570 may take place in addition or as an alternative to the NRPPa messaging (shown by arrows 530 and 550). Moreover, alternative embodiments may utilize different LPP messages and/or utilize LPP messaging at different times during the ECID positioning process.

According to some embodiments, the UE 505 may leverage this ECID LPP messaging to inform the location server 520 of UE-specific TA adjustments. This may include, for example, reporting N_{TA,adj}^{UE} to the location server 520 (e.g., in an ECID provide location information. Message, as shown by arrow 570) In such embodiments, the location server 520 may obtain the term N_{TA,adj}^{common} in an NRPPa message from the NG-RAN node 510 (e.g., in the ECID measurement response/failure report provided at arrow 550) to be able to determine the total UE-side timing advance adjustments T_{Adj}.

According to some embodiments, the terms N_{TA,adj}^{UE} and N_{TA,adj}^{common} may both be provided to the location server 520 via NRPPa messaging to the location server 520 in ECID positioning. In such embodiments, the UE 505 may provide N_{TA,adj}^{UE} to the NG-RAN node 510 (e.g., during the RRC measurement procedure 540 or a report related thereto), and the NG-RAN node 510 can then pass that term along to the location server 520, along with the N_{TA,adj}^{common} term. This may be provided to the location server 520 by the NG-RAN node 510 in the ECID measurement response/failure report provided at arrow 550, for example.

In the PRACH process, a UE may attempt to perform random access multiple times until a random access response (RAR) is received. Because NTN satellites (e.g., LEO satellites) or other NTN aerial vehicles may move quickly, this may mean that the N_{TA,Adj}^{UE} may be different for different random access attempts. To help ensure the UE reports the correct N_{TA,Adj}^{UE} for the successful attempt, embodiments may provide for buffering of this value at the UE.

According to a first technique, a NG-RAN node may include an additional bit (or other such flag) in the downlink control information (DCI) of the corresponding physical downlink control channel (PDCCH) order sent to the UE for performing random access. If the UE finds this flag in the DCI, it can then buffer N_{TA,Adj}^{UE} values and report the value for the successful random-access attempt (e.g., “Mssg1 Tx” as described in relevant specifications) for that PDCCH order (e.g., in accordance with one or more of the techniques described above with regard to FIG. 5). According to some embodiments, the UE may flush the buffer storing the N_{TA,Adj}^{UE} value of the successful attempt once the RAR (Mssg 2) is received.

According to a second technique, the UE can buffer values for N_{TA,Adj}^{UE} automatically, without explicit instructions to do so by the NG-RAN node. That is, when performing contention free random-access, the UE may always buffer the value for N_{TA,Adj}^{UE} corresponding to the last successful random-access attempt (Mssg1 Tx). The UE may then provide this value to the network using, for example, one of the previously-described techniques.

As noted, regarding the reporting of the N_{TA,Adj}^{UE} value (and N_{TA,adj}^{common} value) may proceed generally as described with regard to FIG. 5. However, specific aspects may vary, depending on desired functionality. According to a first option, for example, a location server may send and ECID request to both the UE and the NG-RAN node. In response, the UE can then include the N_{TA,Adj}^{UE} value and a timestamp corresponding to the last successful random-access attempt (Mssg1 Tx) in an LPP message (e.g. ECID-ProvideLocationInformation) reported to the location server. In this option, the UE may provide its capability of reporting TA adjustment values in a separate message to the location server indicating capabilities (e.g. NR-ECID-ProvideCapabilities), which may be in accordance with LPP. Further, the NG-RAN node may also provide a timestamp of the timestamp of the T_{ADV} measurement in the ECID message provided from the NG-RAN node to the location server (e.g., as shown by arrow 550 in FIG. 5).

According to a second option, the UE may simply report through the NG-RAN node (e.g., all without using LPP messaging to the location server directly). According to this option, the UE can report the value of N_{TA,Adj}^{UE} to the NG-RAN node (e.g., a serving base station) in a media access control-control element (MAC-CE). The UE may also report timestamp in MAC-CE. Here, the timestamp can be provided in terms of frame, subframe, and/or slot index, depending on desired functionality. The NG-RAN node can then relay this information to the location server in an ECID message (e.g., as previously described). In such reporting, according to some embodiments, the NG-RAN node may include any combination of the terms N_{TA,Adj}^{UE}, N_{TA,Adj}^{common} and/or T_{ADV}.

The reporting of the value of N_{TA,Adj}^{UE} to the NG-RAN node in a MAC-CE may be performed in any of a variety of ways. This can be provided, for example, in a timing advance report from the UE to the NG-RAN node. However, this report includes the whole timing advance and may not be accurate. (The granularity, for example, may be in terms of an OFDM slot.) As such, embodiments may include alternatives for providing more accurate reporting. Accordingly, embodiments may utilize techniques to provide more accurate reporting. According to one technique, for example, the UE may indicate a new capability to the NG-RAN node of supporting a new MAC-CE with higher granularity/resolution.

Depending on desired functionality, how and when to report may vary. According to a first option, for example, a UE may mark a “TA report” as pending after finalizing a contention free random access. The UE may also report the new MAC-CE in a future uplink grant (depending on Logical Channel ID (LCID) prioritization). Alternatively, the UE may transmit a scheduling request to get a grant to transmit the TA report. According to a second option, the NG-RAN node may send a MAC-CE to the UE requesting the value of N_{TA,Adj}^{UE}. In response, the UE may then transmit the report with the value of N_{TA,Adj}^{UE} in an uplink grant. In some embodiments, the MAC-CE used in the embodiments described herein may be mapped (e.g., exclusively) to hybrid automatic repeat request (HARQ) processes with HARQ enabled. This can allow the MAC-CE to be linked to the HARQ IDs issued in the HARQ processes.

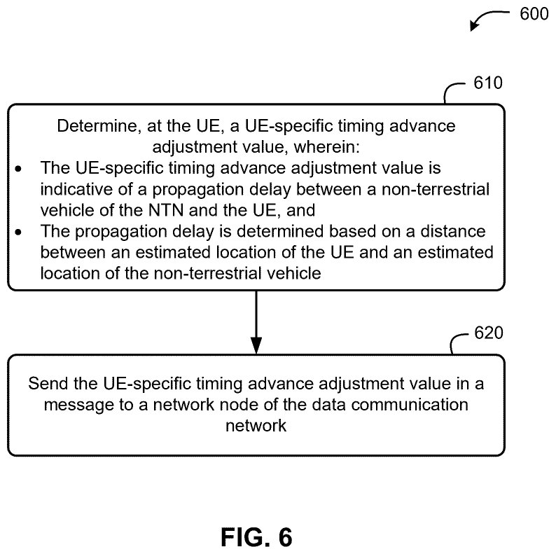

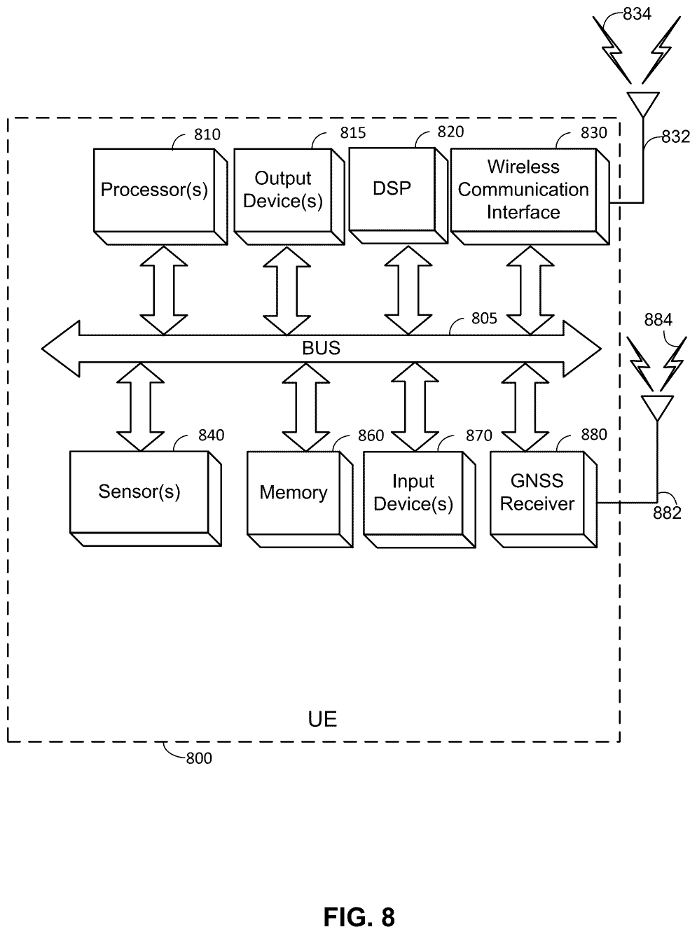

FIG. 6 is a flow diagram of a method 600 of method at a UE of reporting time advance of the UE for NTN positioning in a data communication network, according to an embodiment. Means for performing the functionality illustrated in one or more of the blocks shown in FIG. 6 may be performed by hardware and/or software components of a UE. Example components of a UE are illustrated in FIG. 8, which is described in more detail below.

At block 610, the functionality comprises determining, at the UE, a UE-specific timing advance adjustment value, wherein the UE-specific timing advance adjustment value is indicative of a propagation delay between a non-terrestrial vehicle of the NTN and the UE, and the propagation delay is determined based on a distance between an estimated location of the UE and an estimated location of the non-terrestrial vehicle. As noted in the previously-described embodiments, the UE-specific timing advance adjustment value may comprise a value for N_{TA,adj}^{UE}, which can be used by the network to accurately determine a total timing advance for the UE. Space vehicle may comprise a satellite (e.g., LEO, MEO, or GEO satellite), airplane, drone, balloon, or other aircraft or spacecraft. The estimated location of the UE may be determined by the UE using GNSS and/or other position-determination means (e.g., using a wireless network such as Wi-Fi, Bluetooth, etc.). Again, the estimated location of the non-terrestrial vehicle may be made by the UE or a device communicatively coupled therewith using ephemeris for a satellite. More generally, location and/or trajectory information may be used to determine an estimated location of the non-terrestrial vehicle.

Means for performing functionality at block 610 may comprise a bus 805, processor(s) 810, DSP 820, wireless communication interface 830, sensor(s) 840, memory 860, GNSS receiver 880, and/or other components of a UE, as illustrated in FIG. 8.

At block 620, the functionality comprises sending the UE-specific timing advance adjustment value in a message to a network node of the data communication network. As noted in the embodiments described previously, the network node may comprise an NG-RAN node or location server of a communication network (e.g., 5G cellular network). The NG-RAN node may comprise a base station (e.g., gNB) and/or a TRP connected therewith (e.g., the non-terrestrial vehicle) if, for example.

Embodiments may implement one or more additional features in instances in which the network node comprises an NG-RAN node. For example, according to some embodiments, sending the UE-specific timing advance adjustment value to the NG-RAN node may comprise including the UE-specific timing advance adjustment value in an MAC-CE. As noted in the embodiments described herein, the UE may attempt to perform random access multiple times until an RAR is received, and the UE-specific timing advance adjustment value corresponding to the successful random access attempt may be provided by the UE. Accordingly, some embodiments of the method 600 may further comprise including a timestamp of a successful random access attempt in the MAC-CE. In some embodiments, the timestamp may be provided in terms of OFDM frame, subframe, or slot index, or a combination thereof. Some embodiments may comprise including the UE-specific timing advance adjustment value in the MAC-CE responsive to receiving an uplink grant. Some embodiments may comprise including the UE-specific timing advance adjustment value in the MAC-CE responsive to receiving a request in a separate MAC-CE, from an NG-RAN node, for the UE-specific timing advance adjustment value.

Embodiments may implement one or more additional features in instances in which the network node comprises a location server. For example, in such embodiments, the message may comprise an LPP ECID message. In such embodiments, the method 600 may further comprise receiving an ECID request from the location server, wherein sending the UE-specific timing advance adjustment value in the LPP ECID message is responsive to the ECID request. In some embodiments, the method 600 may comprise, prior to sending the UE-specific timing advance adjustment value in the LPP ECID message, sending capability information to the location server indicative of a capability of the UE for sending the UE-specific timing advance adjustment value in the LPP ECID message.

Again, buffering of the UE-specific timing advance adjustment value may be performed in different ways, depending on desired functionality. According to some embodiments, the method may comprise performing a plurality of random access attempts, wherein the UE-specific timing advance adjustment value corresponds with a successful one of the plurality of random access attempts. As noted, the UE may store the UE-specific timing advance adjustment value responsive to an indication to store the UE-specific timing advance adjustment value received in DCI of a corresponding PDCCH order for performing a plurality of random access attempts.

Means for performing functionality at block 620 may comprise a bus 805, processor(s) 810, DSP 820, wireless communication interface 830, sensor(s) 840, memory 860, GNSS receiver 880, and/or other components of a UE, as illustrated in FIG. 8.

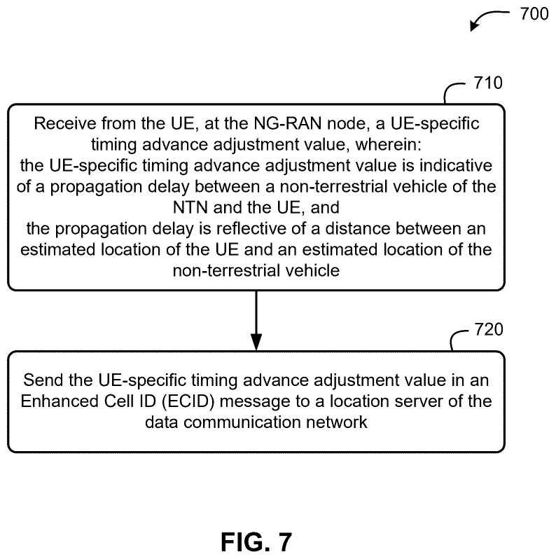

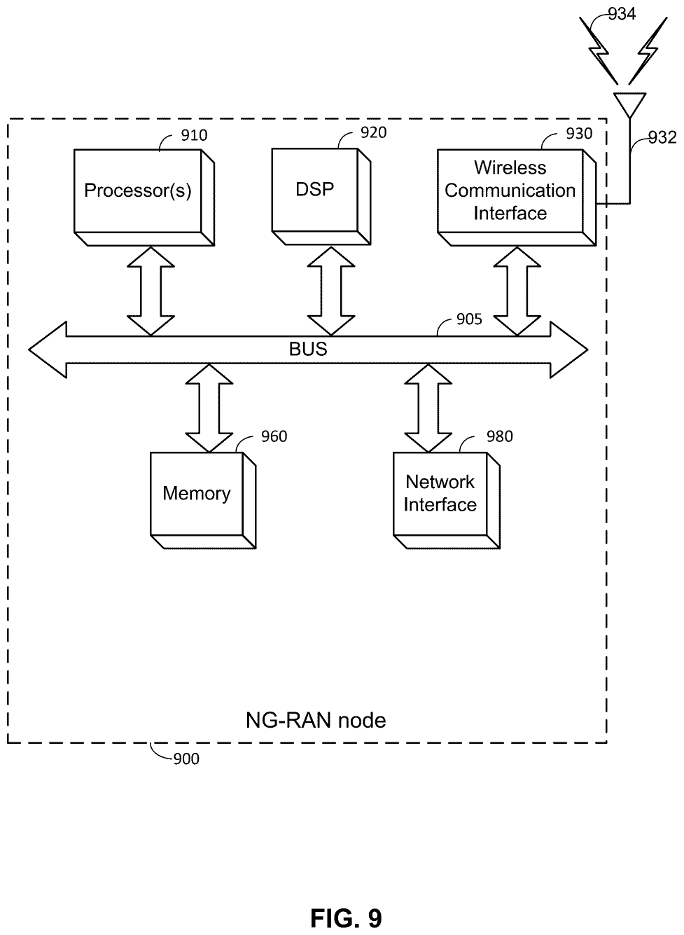

FIG. 7 is a flow diagram of a method 700 of method at an NG-RAN node of reporting time advance of a UE for NTN positioning in a data communication network, according to an embodiment. Means for performing the functionality illustrated in one or more of the blocks shown in FIG. 7 may be performed by hardware and/or software components of a NG-RAN node. Example components of a NG-RAN node are illustrated in FIG. 9, which is described in more detail below.

At block 710, the functionality comprises receiving from the UE, at the NG-RAN node, a UE-specific timing advance adjustment value, wherein the UE-specific timing advance adjustment value is indicative of a propagation delay between a non-terrestrial vehicle of the NTN and the UE, and the propagation delay is reflective of a distance between an estimated location of the UE and an estimated location of the non-terrestrial vehicle. Again, the UE may obtain the estimated location of the UE and estimated location of the non-terrestrial vehicle using different means, as previously described. According to some embodiments, receiving the UE-specific timing advance adjustment value from the UE may comprise receiving the UE-specific timing advance adjustment value in a MAC-CE. In such embodiments, the method 700 may further comprise sending request to the UE, in a separate MAC-CE (prior to receiving the UE-specific timing advance adjustment value), for the UE-specific timing advance adjustment value.

Means for performing functionality at block 710 may comprise a bus 905, processor(s) 910, DSP 920, wireless communication interface 930, memory 960, and/or other components of a UE, as illustrated in FIG. 9.

At block 720, the functionality comprises sending the UE-specific timing advance adjustment value in an ECID message to a location server of the data communication network. As described with regard to FIG. 5, the ECID message may be sent as part of an ECID positioning procedure, and may be sent in accordance with NRPPa. As noted, according to some embodiments, a group common timing advance adjustment value (e.g., N_{TA,adj}^{common}), a timing advance value (e.g., T_{ADV}), or both, may be included in the ECID message. Some embodiments may further comprise sending an indication to the UE to store the UE-specific timing advance adjustment value, wherein the indication is sent in DCI of a PDCCH order for performing a random access.

Means for performing functionality at block 720 may comprise a bus 905, processor(s) 910, DSP 920, wireless communication interface 930, memory 960, and/or other components of a UE, as illustrated in FIG. 9.

FIG. 8 is a block diagram of an embodiment of a UE 800, which can be utilized as described herein above (e.g., in association with FIGS. 1-7). For example, the UE 800 can perform one or more of the functions of the method shown in FIG. 6. It should be noted that FIG. 8 is meant only to provide a generalized illustration of various components, any or all of which may be utilized as appropriate. It can be noted that, in some instances, components illustrated by FIG. 8 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 8.

The UE 800 is shown comprising hardware elements that can be electrically coupled via a bus 805 (or may otherwise be in communication, as appropriate). The hardware elements may include a processor(s) 810 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 810 may comprise one or more processing units, which may be housed in a single integrated circuit (IC) or multiple ICs. As shown in FIG. 8, some embodiments may have a separate DSP 820, depending on desired functionality. Location determination and/or other determinations based on wireless communication may be provided in the processor(s) 810 and/or wireless communication interface 830 (discussed below). The UE 800 also can include one or more input devices 870, which can include without limitation one or more keyboards, touch screens, touch pads, microphones, buttons, dials, switches, and/or the like; and one or more output devices 815, which can include without limitation one or more displays (e.g., touch screens), light emitting diodes (LEDs), speakers, and/or the like.

The UE 800 may also include a wireless communication interface 830, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 800 to communicate with other devices as described in the embodiments above. The wireless communication interface 830 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 832 that send and/or receive wireless signals 834. According to some embodiments, the wireless communication antenna(s) 832 may comprise a plurality of discrete antennas, antenna arrays, or any combination thereof. The antenna(s) 832 may be capable of transmitting and receiving wireless signals using beams (e.g., Tx beams and Rx beams). Beam formation may be performed using digital and/or analog beam formation techniques, with respective digital and/or analog circuitry. The wireless communication interface 830 may include such circuitry.

Depending on desired functionality, the wireless communication interface 830 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 800 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 800 can further include sensor(s) 840. Sensor(s) 840 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 800 may also include a Global Navigation Satellite System (GNSS) receiver 880 capable of receiving signals 884 from one or more GNSS satellites using an antenna 882 (which could be the same as antenna 832). Positioning based on GNSS signal measurement can be utilized to complement and/or incorporate the techniques described herein. The GNSS receiver 880 can extract a position of the UE 800, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 880 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 880 is illustrated in FIG. 8 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 810, DSP 820, and/or a processor within the wireless communication interface 830 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 810 or DSP 820.

The UE 800 may further include and/or be in communication with a memory 860. The memory 860 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 860 of the UE 800 also can comprise software elements (not shown in FIG. 8), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 860 that are executable by the UE 800 (and/or processor(s) 810 or DSP 820 within UE 800). In some embodiments, then, such code and/or instructions can be used to configure and/or adapt a general-purpose computer (or other device) to perform one or more operations in accordance with the described methods.

FIG. 9 is a block diagram of an embodiment of a NG-RAN node 900, which can be utilized as described herein above (e.g., in association with FIGS. 1-8). It should be noted that FIG. 9 is meant only to provide a generalized illustration of various components, any or all of which may be utilized as appropriate. In some embodiments, the NG-RAN node 900 may correspond to a gNB, an ng-eNB, and/or (more generally) a TRP.

The NG-RAN node 900 is shown comprising hardware elements that can be electrically coupled via a bus 905 (or may otherwise be in communication, as appropriate). The hardware elements may include a processor(s) 910 which can include without limitation one or more general-purpose processors, one or more special-purpose processors (such as DSP chips, graphics acceleration processors, ASICs, and/or the like), and/or other processing structure or means. As shown in FIG. 9, some embodiments may have a separate DSP 920, depending on desired functionality. Location determination and/or other determinations based on wireless communication may be provided in the processor(s) 910 and/or wireless communication interface 930 (discussed below), according to some embodiments. The NG-RAN node 900 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The NG-RAN node 900 might also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the NG-RAN node 900 to communicate as described herein. The wireless communication interface 930 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 932 that send and/or receive wireless signals 934.

The NG-RAN node 900 may also include a network interface 980, which can include support of wireline communication technologies. The network interface 980 may include a modem, network card, chipset, and/or the like. The network interface 980 may include one or more input and/or output communication interfaces to permit data to be exchanged with a network, communication network servers, computer systems, and/or any other electronic devices described herein.

In many embodiments, the NG-RAN node 900 may further comprise a memory 960. The memory 960 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 960 of the NG-RAN node 900 also may comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the NG-RAN node 900 (and/or processor(s) 910 or DSP 920 within NG-RAN node 900). In some embodiments, then, such code and/or instructions can be used to configure and/or adapt a general-purpose computer (or other device) to perform one or more operations in accordance with the described methods.

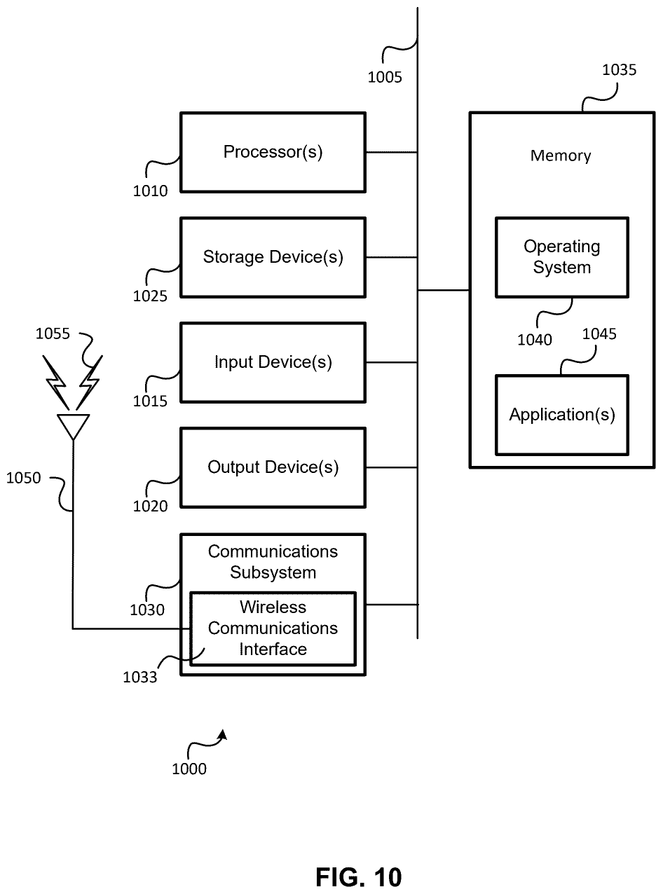

FIG. 10 is a block diagram of an embodiment of a computer system 1000, which may be used, in whole or in part, to provide the functions of one or more network components as described in the embodiments herein (e.g., a location server). It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner. In addition, it can be noted that components illustrated by FIG. 10 can be localized to a single device and/or distributed among various networked devices, which may be disposed at different geographical locations.

The computer system 1000 is shown comprising hardware elements that can be electrically coupled via a bus 1005 (or may otherwise be in communication, as appropriate). The hardware elements may include processor(s) 1010, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1000 also may comprise one or more input devices 1015, which may comprise without limitation a mouse, a keyboard, a camera, a microphone, and/or the like; and one or more output devices 1020, which may comprise without limitation a display device, a printer, and/or the like.

The computer system 1000 may further include (and/or be in communication with) one or more non-transitory storage devices 1025, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1000 may also include a communications subsystem 1030, which may comprise wireless communication technologies managed and controlled by a wireless communication interface 1033, as well as wired technologies (such as Ethernet, coaxial communications, universal serial bus (USB), and the like). The wireless communication interface 1033 may comprise one or more wireless transceivers that may send and receive wireless signals 1055 (e.g., signals according to 5G NR or LTE) via wireless antenna(s) 1050. Thus the communications subsystem 1030 may comprise a modem, a network card (wireless or wired), an infrared communication device, a wireless communication device, and/or a chipset, and/or the like, which may enable the computer system 1000 to communicate on any or all of the communication networks described herein to any device on the respective network, including a User Equipment (UE), base stations and/or other TRPs, and/or any other electronic devices described herein. Hence, the communications subsystem 1030 may be used to receive and send data as described in the embodiments herein.

In many embodiments, the computer system 1000 will further comprise a working memory 1035, which may comprise a RAM or ROM device, as described above. Software elements, shown as being located within the working memory 1035, may comprise an operating system 1040, device drivers, executable libraries, and/or other code, such as one or more applications 1045, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1025 described above. In some cases, the storage medium might be incorporated within a computer system, such as computer system 1000. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1000 and/or might take the form of source and/or installable code, which, upon compilation and/or installation on the computer system 1000 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method at a user equipment (UE) of reporting time advance of the UE for non-terrestrial network (NTN) positioning in a data communication network, the method comprising: determining, at the UE, a UE-specific timing advance adjustment value, wherein: the UE-specific timing advance adjustment value is indicative of a propagation delay between a non-terrestrial vehicle of the NTN and the UE, and the propagation delay is determined based on a distance between an estimated location of the UE and an estimated location of the non-terrestrial vehicle; and sending the UE-specific timing advance adjustment value in a message to a network node of the data communication network.
Clause 2. The method of clause 1, wherein the network node comprises a next generation radio access network (NG-RAN) node of the data communication network.
Clause 3. The method of clause 2 wherein sending the UE-specific timing advance adjustment value to the NG-RAN node comprises including the UE-specific timing advance adjustment value in a media access control-control element (MAC-CE).
Clause 4. The method of clause 3 further including a timestamp of a successful random access attempt in the MAC-CE, wherein the timestamp provided in terms of an Orthogonal Frequency Division Multiplexing (OFDM) frame, subframe, or slot index, or a combination thereof.
Clause 5. The method of any one of clauses 3-4 wherein including the UE-specific timing advance adjustment value in the MAC-CE is responsive to receiving an uplink grant.
Clause 6. The method of any one of clauses 3-5 wherein including the UE-specific timing advance adjustment value in the MAC-CE is responsive to receiving a request in a separate MAC-CE, from an NG-RAN node, for the UE-specific timing advance adjustment value.
Clause 7. The method of any one of clauses 1-2 wherein the network node comprises a location server of the data communication network and the message comprises a long-term evolution (LTE) positioning protocol (LPP) Enhanced Cell ID (ECID) message.
Clause 8. The method of clause 7 further comprising receiving an ECID request from the location server, wherein sending the UE-specific timing advance adjustment value in the LPP ECID message is responsive to the ECID request.
Clause 9. The method of any one of clauses 7-8 further comprising, prior to sending the UE-specific timing advance adjustment value in the LPP ECID message, sending capability information to the location server indicative of a capability of the UE for sending the UE-specific timing advance adjustment value in the LPP ECID message.
Clause 10. The method of any one of clauses 1-9 further comprising performing a plurality of random access attempts, wherein the UE-specific timing advance adjustment value corresponds with a successful one of the plurality of random access attempts.
Clause 11. The method of claim 10 further comprising storing the UE-specific timing advance adjustment value responsive to an indication to store the UE-specific timing advance adjustment value received in downlink control information (DCI) of a corresponding physical downlink control channel (PDCCH) order for performing a plurality of random access attempts.
Clause 12. A method at a next generation radio access network (NG-RAN) node of reporting time advance of a user equipment (UE) for non-terrestrial network (NTN) positioning in a data communication network, the method comprising: receiving from the UE, at the NG-RAN node, a UE-specific timing advance adjustment value, wherein: the UE-specific timing advance adjustment value is indicative of a propagation delay between a non-terrestrial vehicle of the NTN and the UE, and the propagation delay is reflective of a distance between an estimated location of the UE and an estimated location of the non-terrestrial vehicle; and sending the UE-specific timing advance adjustment value in an Enhanced Cell ID (ECID) message to a location server of the data communication network.
Clause 13. The method of clause 12, wherein the ECID message is sent in accordance with new radio (NR) positioning protocol annex (NRPPa).
Clause 14. The method of any one of clauses 12-13 wherein receiving the UE-specific timing advance adjustment value from the UE comprises receiving the UE-specific timing advance adjustment value in a media access control-control element (MAC-CE).
Clause 15. The method of clause 14 further comprising sending request to the UE, in a separate MAC-CE, for the UE-specific timing advance adjustment value.
Clause 16. The method of any one of clauses 12-15 further comprising including a group common timing advance adjustment value, a timing advance value, or both, in the ECID message.
Clause 17. The method of any one of clauses 12-16 further comprising sending an indication to the UE to store the UE-specific timing advance adjustment value, wherein the indication is sent in downlink control information (DCI) of a physical downlink control channel (PDCCH) order for performing a random access.
Clause 18. A user equipment (UE) for reporting time advance of the UE for non-terrestrial network (NTN) positioning in a data communication network, the UE comprising: a transceiver; a memory; and one or more processors communicatively coupled with the transceiver and the memory, wherein the one or more processors are configured to: determine a UE-specific timing advance adjustment value, wherein: the UE-specific timing advance adjustment value is indicative of a propagation delay between a non-terrestrial vehicle of the NTN and the UE, and the propagation delay is determined based on a distance between an estimated location of the UE and an estimated location of the non-terrestrial vehicle; and send, via the transceiver, the UE-specific timing advance adjustment value in a message to a network node of the data communication network.
Clause 19. The UE of clause 18, wherein, to send the UE-specific timing advance adjustment value in the message to the network node, the one or more processors are configured to send the UE-specific timing advance adjustment value in the message to a next generation radio access network (NG-RAN) node of the data communication network.
Clause 20. The UE of any clause 19 wherein, to send the UE-specific timing advance adjustment value to the NG-RAN node, the one or more processors are configured to include the UE-specific timing advance adjustment value in a media access control-control element (MAC-CE).
Clause 21. The UE of clause 20 wherein the one or more processors are configured to include a timestamp of a successful random access attempt in the MAC-CE, wherein the timestamp provided in terms of an Orthogonal Frequency Division Multiplexing (OFDM) frame, subframe, or slot index, or a combination thereof.
Clause 22. The UE of any one of clauses 20-21 wherein the one or more processors are configured to include the UE-specific timing advance adjustment value in the MAC-CE responsive to the UE receiving an uplink grant.
Clause 23. The UE of any one of clauses 18-22 wherein the one or more processors are configured to include the UE-specific timing advance adjustment value in the MAC-CE responsive to the UE receiving a request in a separate MAC-CE, from an NG-RAN node, for the UE-specific timing advance adjustment value.
Clause 24. The UE of clause 18 wherein, to send the UE-specific timing advance adjustment value in the message to the network node, the one or more processors are configured to send the UE-specific timing advance adjustment value in the message to a location server of the data communication network, and wherein the message comprises a long-term evolution (LTE) positioning protocol (LPP) Enhanced Cell ID (ECID) message.
Clause 25. The UE of any one of clauses 18-24 wherein the one or more processors are further configured to perform a plurality of random access attempts, wherein the UE-specific timing advance adjustment value corresponds with a successful one of the plurality of random access attempts.
Clause 26. A NG-RAN for reporting time advance of a user equipment (UE) for non-terrestrial network (NTN) positioning in a data communication network, the NG-RAN comprising: a transceiver; a memory; and one or more processors communicatively coupled with the transceiver and the memory, wherein the one or more processors are configured to: receive from the UE, via the transceiver, a UE-specific timing advance adjustment value, wherein: the UE-specific timing advance adjustment value is indicative of a propagation delay between a non-terrestrial vehicle of the NTN and the UE, and the propagation delay is reflective of a distance between an estimated location of the UE and an estimated location of the non-terrestrial vehicle; and send, via the transceiver, the UE-specific timing advance adjustment value in an Enhanced Cell ID (ECID) message to a location server of the data communication network.
Clause 27. The NG-RAN of clause 26, wherein the one or more processors are configured to send the ECID message in accordance with new radio (NR) positioning protocol annex (NRPPa).
Clause 28. The NG-RAN of any one of clauses 26-27 wherein, to receive the UE-specific timing advance adjustment value from the UE, the one or more processors are configured to receive the UE-specific timing advance adjustment value in a media access control-control element (MAC-CE).
Clause 29. The NG-RAN of any one of clauses 26-28 wherein the one or more processors are further configured to include a group common timing advance adjustment value, a timing advance value, or both, in the ECID message.
Clause 30. The NG-RAN of any one of clauses 26-29 wherein the one or more processors are further configured to send an indication to the UE to store the UE-specific timing advance adjustment value, wherein the indication is sent in downlink control information (DCI) of a physical downlink control channel (PDCCH) order for performing a random access.

What is claimed is:

1. A method at a user equipment (UE) of reporting time advance of the UE for non-terrestrial network (NTN) positioning in a data communication network, the method comprising:
determining, at the UE, a UE-specific timing advance adjustment value, wherein:
the UE-specific timing advance adjustment value is indicative of a propagation delay between a non-terrestrial vehicle of the NTN and the UE, and
the propagation delay is determined based on a distance between an estimated location of the UE and an estimated location of the non-terrestrial vehicle; and
sending the UE-specific timing advance adjustment value in a message to a network node of the data communication network.

2. The method of claim 1, wherein the network node comprises a next generation radio access network (NG-RAN) node of the data communication network.

3. The method of claim 2, wherein sending the UE-specific timing advance adjustment value to the NG-RAN node comprises including the UE-specific timing advance adjustment value in a media access control-control element (MAC-CE).

4. The method of claim 3, further including a timestamp of a successful random access attempt in the MAC-CE, wherein the timestamp provided in terms of an Orthogonal Frequency Division Multiplexing (OFDM) frame, subframe, or slot index, or a combination thereof.

5. The method of claim 3, wherein including the UE-specific timing advance adjustment value in the MAC-CE is responsive to receiving an uplink grant.

6. The method of claim 3, wherein including the UE-specific timing advance adjustment value in the MAC-CE is responsive to receiving a request in a separate MAC-CE, from an NG-RAN node, for the UE-specific timing advance adjustment value.

7. The method of claim 1, wherein the network node comprises a location server of the data communication network and the message comprises a long-term evolution (LTE) positioning protocol (LPP) Enhanced Cell ID (ECID) message.

8. The method of claim 7, further comprising receiving an ECID request from the location server, wherein sending the UE-specific timing advance adjustment value in the LPP ECID message is responsive to the ECID request.

9. The method of claim 7, further comprising, prior to sending the UE-specific timing advance adjustment value in the LPP ECID message, sending capability information to the location server indicative of a capability of the UE for sending the UE-specific timing advance adjustment value in the LPP ECID message.

10. The method of claim 1, further comprising performing a plurality of random access attempts, wherein the UE-specific timing advance adjustment value corresponds with a successful one of the plurality of random access attempts.

11. The method of claim 10, further comprising storing the UE-specific timing advance adjustment value responsive to an indication to store the UE-specific timing advance adjustment value received in downlink control information (DCI) of a corresponding physical downlink control channel (PDCCH) order for performing a plurality of random access attempts.

12. A method at a next generation radio access network (NG-RAN) node of reporting time advance of a user equipment (UE) for non-terrestrial network (NTN) positioning in a data communication network, the method comprising:
receiving from the UE, at the NG-RAN node, a UE-specific timing advance adjustment value, wherein:
the UE-specific timing advance adjustment value is indicative of a propagation delay between a non-terrestrial vehicle of the NTN and the UE, and
the propagation delay is reflective of a distance between an estimated location of the UE and an estimated location of the non-terrestrial vehicle; and
sending the UE-specific timing advance adjustment value in an Enhanced Cell ID (ECID) message to a location server of the data communication network.

13. The method of claim 12, wherein the ECID message is sent in accordance with new radio (NR) positioning protocol annex (NRPPa).

14. The method of claim 12, wherein receiving the UE-specific timing advance adjustment value from the UE comprises receiving the UE-specific timing advance adjustment value in a media access control-control element (MAC-CE).

15. The method of claim 14, further comprising sending request to the UE, in a separate MAC-CE, for the UE-specific timing advance adjustment value.

16. The method of claim 12, further comprising including a group common timing advance adjustment value, a timing advance value, or both, in the ECID message.

17. The method of claim 12, further comprising sending an indication to the UE to store the UE-specific timing advance adjustment value, wherein the indication is sent in downlink control information (DCI) of a physical downlink control channel (PDCCH) order for performing a random access.

18. A user equipment (UE) for reporting time advance of the UE for non-terrestrial network (NTN) positioning in a data communication network, the UE comprising:
a transceiver;
a memory; and
one or more processors communicatively coupled with the transceiver and the memory, wherein the one or more processors are configured to:
determine a UE-specific timing advance adjustment value, wherein:
the UE-specific timing advance adjustment value is indicative of a propagation delay between a non-terrestrial vehicle of the NTN and the UE, and
the propagation delay is determined based on a distance between an estimated location of the UE and an estimated location of the non-terrestrial vehicle; and
send, via the transceiver, the UE-specific timing advance adjustment value in a message to a network node of the data communication network.

19. The UE of claim 18, wherein, to send the UE-specific timing advance adjustment value in the message to the network node, the one or more processors are configured to send the UE-specific timing advance adjustment value in the message to a next generation radio access network (NG-RAN) node of the data communication network.

20. The UE of claim 19, wherein, to send the UE-specific timing advance adjustment value to the NG-RAN node, the one or more processors are configured to include the UE-specific timing advance adjustment value in a media access control-control element (MAC-CE).

21. The UE of claim 20, wherein the one or more processors are configured to include a timestamp of a successful random access attempt in the MAC-CE, wherein the timestamp provided in terms of an Orthogonal Frequency Division Multiplexing (OFDM) frame, subframe, or slot index, or a combination thereof.

22. The UE of claim 20, wherein the one or more processors are configured to include the UE-specific timing advance adjustment value in the MAC-CE responsive to the UE receiving an uplink grant.

23. The UE of claim 20, wherein the one or more processors are configured to include the UE-specific timing advance adjustment value in the MAC-CE responsive to the UE receiving a request in a separate MAC-CE, from an NG-RAN node, for the UE-specific timing advance adjustment value.

24. The UE of claim 18, wherein, to send the UE-specific timing advance adjustment value in the message to the network node, the one or more processors are configured to send the UE-specific timing advance adjustment value in the message to a location server of the data communication network, and wherein the message comprises a long-term evolution (LTE) positioning protocol (LPP) Enhanced Cell ID (ECID) message.

25. The UE of claim 18, wherein the one or more processors are further configured to perform a plurality of random access attempts, wherein the UE-specific timing advance adjustment value corresponds with a successful one of the plurality of random access attempts.

26. A NG-RAN for reporting time advance of a user equipment (UE) for non-terrestrial network (NTN) positioning in a data communication network, the NG-RAN comprising:
a transceiver;
a memory; and
one or more processors communicatively coupled with the transceiver and the memory, wherein the one or more processors are configured to:
receive from the UE, via the transceiver, a UE-specific timing advance adjustment value, wherein:
the UE-specific timing advance adjustment value is indicative of a propagation delay between a non-terrestrial vehicle of the NTN and the UE, and
the propagation delay is reflective of a distance between an estimated location of the UE and an estimated location of the non-terrestrial vehicle; and
send, via the transceiver, the UE-specific timing advance adjustment value in an Enhanced Cell ID (ECID) message to a location server of the data communication network.

27. The NG-RAN of claim 26, wherein the one or more processors are configured to send the ECID message in accordance with new radio (NR) positioning protocol annex (NRPPa).

28. The NG-RAN of claim 26, wherein, to receive the UE-specific timing advance adjustment value from the UE, the one or more processors are configured to receive the UE-specific timing advance adjustment value in a media access control-control element (MAC-CE).

29. The NG-RAN of claim 26, wherein the one or more processors are further configured to include a group common timing advance adjustment value, a timing advance value, or both, in the ECID message.

30. The NG-RAN of claim 26, wherein the one or more processors are further configured to send an indication to the UE to store the UE-specific timing advance adjustment value, wherein the indication is sent in downlink control information (DCI) of a physical downlink control channel (PDCCH) order for performing a random access.
